(19) United States
(12) Patent Application Publication
(10) Pub. No.: US 2012/0331172 A1
(43) Pub. Date: Dec. 27, 2012

(54) Method And System For Improved Performance Of Network Communications With Interface Specific Buffers

(75) Inventors: Vishal R. Mansur, Bangalore (IN); Vijeyalakshumi Koteeswaran, Chennai (IN); Omar Cardona, Cedar Park, TX (US); Arnab Tah, Chandannagar (IN)

(73) Assignee: International Business Machines Corporation, Armonk, NY (US)

(21) Appl. No.: 13/165,943

(22) Filed: Jun. 22, 2011

(51) Int. Cl. G06F 15/16

(52) U.S. Cl. 709/234

(57) ABSTRACT

Network adapter use of an interface specific buffer is managed so that their combined use with non-interface specific buffers has a reduced impact, such as when an interface specific buffer becomes full. If an attempt fails by a protocol stack of an operating system to buffer information for a packet in an interface specific buffer, an offset marks the end of the use of the interface specific buffer for the packet and a non-interface specific buffer is used to store the remaining information for the packet. During transmission of the packet, the offset is read by a network adapter driver to take advantage of reduced processing for sending information from the interface specific buffer and to identify information that need additional processing for transmission from the non-interface specific buffer.

### BACKGROUND OF THE INVENTION

1. Field of the Invention

The present invention relates in general to the field of networked communications, and more particularly to a method and system for improved performance of network communications with interface specific buffers.

2. Description of the Related Art

In order to improve communication of network information through a network adapter device, the AIX operating system available from INTERNATIONAL BUSINESS MACHINES CORPORATION (IBM) uses interface specific buffers, such as is set forth in greater detail by the following patent applications that are incorporated herein by reference: U.S. patent application Ser. No. 11/751,323, filed on May 21, 2007, and U.S. patent application Ser. No. 11/751,302, filed on May 21, 2007, both assigned to International Business Machines Corporation. In summary, interface specific buffers operate by pre-mapping memory for use by network adapter device drivers so that memory accesses are reduced during network communications. Information buffered at an interface specific buffer does not have to be copied to a transmitter buffer in order for the information to be sent by the network adapter device, thus making transmission of the information more efficient. In a packet send loop, such as a sosend, after the various network socket states are verified, the socket options are checked to see if a network interface supports buffer management with an interface specific buffer. A flag is set if interface specific buffers are supported by the underlying network adapter on which the interface is created, and an interface specific buffer is requested from the underlying device driver, such as with an IOCTL (IFIOCTL_MGET) call. Upon receiving this call, the device driver checks the size of the buffer requested and, if a buffer of that size is available in the premapped pool of the interface specific buffer, the driver returns the available buffer pointer to the caller. The protocol stack maps the buffer pointer in a chain and copies the data to the interface specific buffer.

### SUMMARY OF THE INVENTION

Therefore, a need has arisen for a system and method which improves network adapter buffer management when interface specific buffers lack room to store information for communication through a network adapter device.

In accordance with the present invention, a system and method are provided which substantially reduce the disadvantages and problems associated with previous methods and systems for buffering information to transmit over a network through a network adapter device. Information for a packet is stored in an interface specific buffer until a request to store information in the interface specific buffer fails. An indicator identifies the information stored in the interface specific buffer and all information after the failure, which is stored in a non-interface specific buffer. Transmission of the packet from a network adapter takes advantage of the efficiency associated with the interface specific buffer until the indicator, and processes information for the packet after the indicator as appropriate.

More specifically, a protocol stack of an operating system running on a computer system processor and memory coordinates communication of packets by a network adapter to a network. The protocol stack stores information for a packet at an interface specific buffer and tracks the information with a buffer chain. Upon completing a packet, a network adapter driver applies the buffer chain to transmit the packet from the interface specific buffer. If the protocol stack fails in an attempt to store information for a packet in the interface specific buffer, such as when the interface specific buffer lacks room to store the information, then the protocol stack indicates the end of the use of the interface specific buffer with an offset in the buffer chain. After failure to store information for a packet in an interface specific buffer, the protocol stack stores all remaining information for the packet in a non-interface specific buffer, such as a system buffer. The offset in the buffer chain indicates the transition between use of an interface specific buffer and non-interface specific buffer for the packet. Upon transmission of the packet, a network adapter driver applies the buffer chain to process the portion of the packet before the offset as information stored in an interface specific buffer and to process the portion of the packet after the offset as information stored in a non-interface specific buffer. For example, information of the packet in the interface specific buffer is transmitted by the network adapter from that location while information of the packet in the non-interface specific buffer is copied to a transmit buffer for communication by the network adapter.

The present invention provides a number of important technical advantages. One example of an important technical advantage is that a scatter gather operation is avoided when non-interface specific buffers are used to store information in combination with interface specific buffers for communication through a network adapter device. Eliminating the need for a scatter gather operation improves network communication performance by reducing processor cycles needed to process buffer locations for transmission through a network adapter. For example, in one embodiment the buffer chain for a packet transmission is only traversed once, thus simplifying the transmit path of a packet transmitted by a network adapter device. Further, a system level optimization is provided by ending requests for interface specific buffers at a packet level once a buffer chain has a request for an interface specific buffer refused. The use of a non-interface specific buffer for the remainder of the packet increases the chances that the next request for an interface specific buffer will get fulfilled completely for an entire packet buffer chain, thus providing more efficient packet transmissions.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a computer system having a network adapter that transmits a packet from an interface specific buffer and non-interface specific buffer based upon an offset in a buffer chain;

FIG. 2 depicts a flow diagram of a process for transmitting a packet from a computer system using both an interface specific buffers and non-interface specific buffer; and

FIG. 3 depicts a flow diagram of a process for determining the type of buffer associated with transmission of a packet.

### DETAILED DESCRIPTION

A system and method provides transmission of packets from a computer network adapter to a network using both interface specific buffers and non-interface specific buffers. During creation of the packet at a transport layer, interface specific buffers are used until a request for an interface specific buffer fails. An offset in a buffer chain that tracks information in the buffer identifies a transition from the use of an interface specific buffer to the use of a non-interface specific buffer so that, upon transmission of the packet, the driver of the network adapter handles information identified by the chain as stored in an interface specific buffer until the offset and as stored in a non-interface specific buffer after the offset.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A difficulty that arises with interface specific buffers is that a driver cannot always use the interface specific buffer, such as when the physical memory supporting the interface specific buffer lacks adequate size to store requested information. If the driver is unable to fetch the requested interface specific buffer from its pool, the driver returns a null and the protocol stack instead gets a buffer from the system network memory pool, which for the purposes herein is a non-interface specific buffer. The system memory buffer is then linked to the buffer pointer in the chain and the data is copied to the system memory buffer. Once all of the data to be sent is copied, the buffer pointer chain is sent to the driver. The driver then performs a “scatter gather” operation on the buffer pointer chain to identify which buffer pointers are interface specific buffers and which are non-interface specific buffers. For the non-interface specific buffers, the driver copies the buffer pointer into a DMA mapped transmit buffer and then initiates the adapter, which finally sends the packet through the network device.

The concept behind interface specific buffers is that a protocol stack, such as TCP/UDP, requests a buffer from the network device driver to rely on a pre-mapped memory pool, a DMA mapped buffer with the network adapter, to avoid making multiple copies of the packet from the stack to the driver's pre-mapped transmit memory. However, when the pre-mapped interface specific buffer memory pool lacks the size needed to handle a packet so that system memory is used instead, the performance benefit offered by pre-mapping is degraded by the need to perform a scatter gather to send the packet. For example, the buffer chain for a packet is traversed once to build a scatter gather list, and then is traversed twice more, once to build the interface specific buffer chain and once to fill transmit descriptors. Multiple parsing of the buffer chain eats up performance benefits otherwise offered by interface specific buffers, such as improved performance provided by avoiding an buffer copy to the transmit buffer. Multiple parsing of the buffer chain also complicates the transmit path in the driver. Since pre-mapped memory associated with interface specific buffers tends to become unavailable during periods of high load, the added overhead of scatter gather operations often impacts network performance at inopportune times.

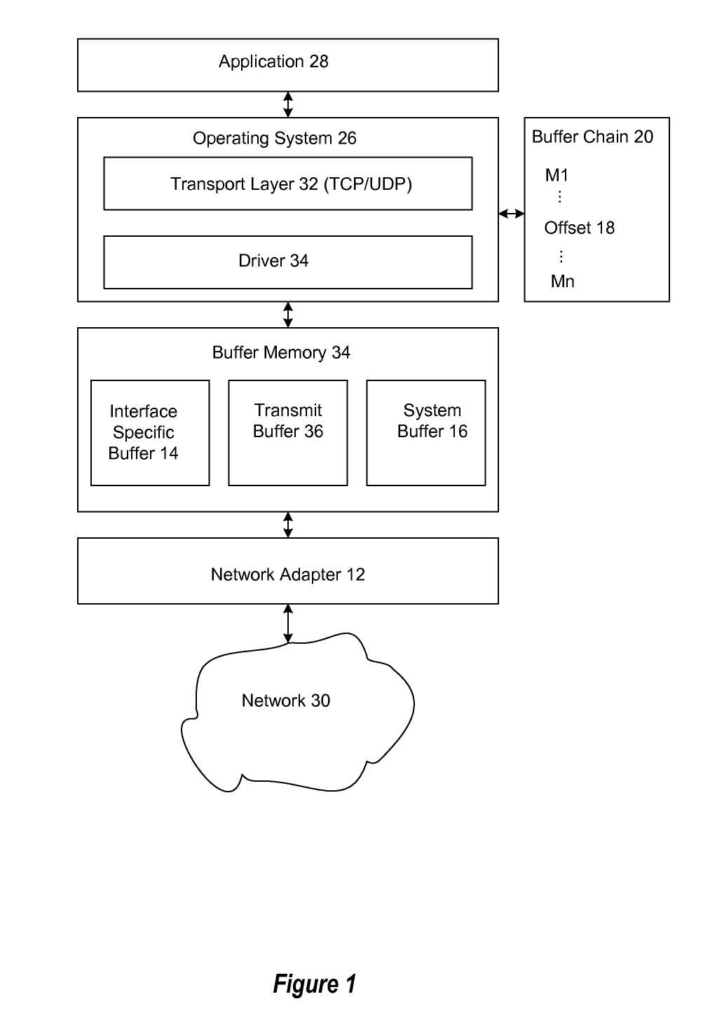

Referring now to FIG. 1, a block diagram depicts a computer system 10 having a network adapter 12 that transmits a packet from an interface specific buffer 14 and non-interface specific buffer 16 based upon an offset 18 in a buffer chain 20. Computer system 10 has a processor 22 and memory 24 that cooperate to execute instructions, such as for running an operating system 26 that supports an application 28, like a word processing program or web browser. Application 28 generates information for transmission by network adapter 12 to a network 30. Operating system 26 includes a transport layer 32 and driver 34 that coordinate transmission of packets by network adapter 12. Transport layer 32, such as a TCP or UDP protocol stack, stores information in buffer memory 34 and maintains a buffer chain 20 of the buffer locations. Once information in buffer memory 34 is ready to send in a packet, driver 34 processes buffer chain 20 to manage transmission of the packet by network adapter 12. Instructions for transport layer 32 and driver 34 may run on processor 22, on a processor and memory within network adapter 12, or distributed among various hardware and software components of computer system 10.

Buffer memory 34 includes an interface specific buffer 14, a system buffer 16 and a transmit buffer 36. Transport layer 32 stores information intended for transmission in a packet in interface specific buffer 14 if space is available for the information in interface specific buffer 14. Interface specific buffer 14 is registered and mapped with network adapted 12 so that information stored in interface specific buffer 14 does not have to be copied to transmit buffer 36 before it is sent as a packet by network adapter 12. However, interface specific buffer 14 can hold the information to await confirmation of the packet and thus can become full during normal operations. In the event that interface specific buffer 14 becomes full, an attempt to save information to interface specific buffer 14 by transport layer 32 will fail. Upon a failure to save information to interface specific buffer 14, transport layer 32 will save an offset 18 that identifies the point in buffer chain 20 at which interface specific buffer 14 became full and will then save information for the packet to a non-interface specific buffer, such as system buffer 16. Transport layer 32 will save all remaining information for the packet to the non-interface specific buffer until the packet is complete so that all buffer memory locations in buffer chain 20 after offset 18 are to the non-interface specific buffer.

When information stored in buffer memory 34 as tracked by buffer chain 20 is ready to send as a packet by network adapter 12, driver 34 accesses buffer chain 20 to coordinate transmission of the packet. Information in buffer chain 20 before processed as interface specific buffer information that is mapped and registered for use by network adapter 12 so that a copy need not be made to transmit buffer 36. Information in buffer chain 20 after offset 18 is managed as a non-interface specific buffer so that a copy of the information is made to transmit buffer 36 before network adapter 12 can include the information in the packet. Since offset 18 defines which information needs interface specific or non-interface specific processing, buffer chain 20 need not be parsed to identify information for copying to transmit buffer 36. For example, offset 18 is stored as part of a buffer header if at least some information of a packet is stored in a non-interface specific buffer. Driver 34 checks the header and treats the entire packet as an interface specific buffer if no offset exists. If an offset exists, driver 34 treats information up to offset 18 as interface specific buffered information and treats information after offset 18 as non-interface specific buffered information that is copied to transmit buffer 36 for communication as a packet.

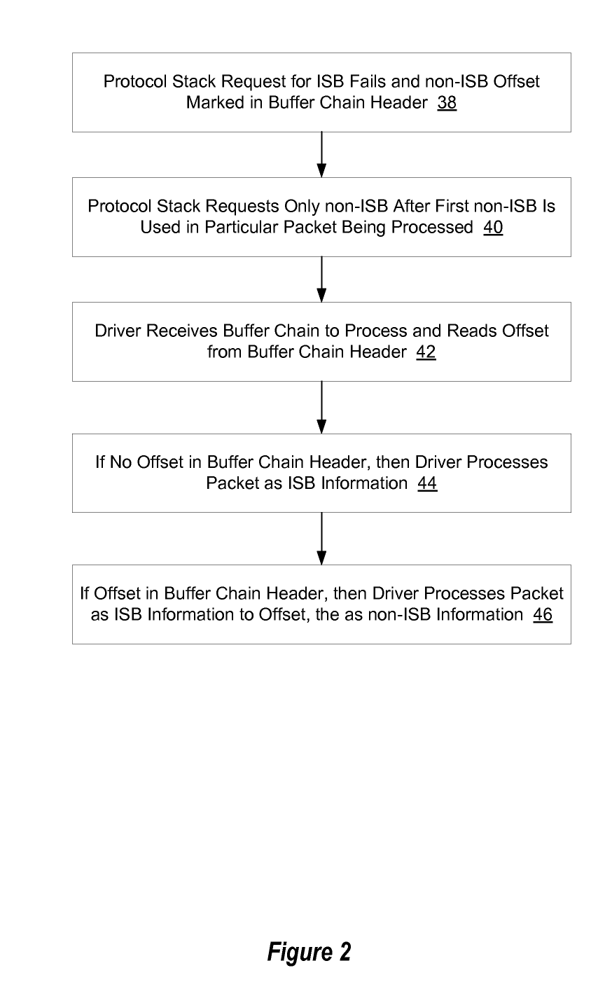

Referring now to FIG. 2, a flow diagram depicts a process for transmitting a packet from a computer system using both an interface specific buffers and non-interface specific buffer. The process begins at step 38 when a request by a protocol stack for an interface specific buffer fails and information for a packet is stored in a non-interface specific buffer, such as a system buffer. The buffer chain that tracks buffer locations for the packet marks the first non-interface specific buffer with a start offset in its buffer chain header options. At step 40, the protocol stack responds to the use of a non-interface specific buffer by requesting non-interface specific buffer space for all remaining information of the particular packet being processed. At step 42, the driver receives a buffer chain of the packet to send the packet from the network adapter and reads the buffer chain header to locate the offset value to determine the start of non-interface specific buffers. At step 44, if the options in the buffer chain are not populated with an offset, the driver assumes all buffer space used to store information for the packet are interface specific buffers mapped and registered with the network adapted and so the driver can send the packet out directly from the interface specific buffer. If at step 46, the buffer chain header options are populated with an offset, then the driver assumes that unmapped buffer locations are used to store information in the chain. The driver copies the information from the locations after the offset to the end of the buffer chain to transmit buffer locations that are mapped and registered with the network adapter. The driver retains information in the interface specific buffers as stored and then sends the packet from the interface specific buffer and transmit buffer.

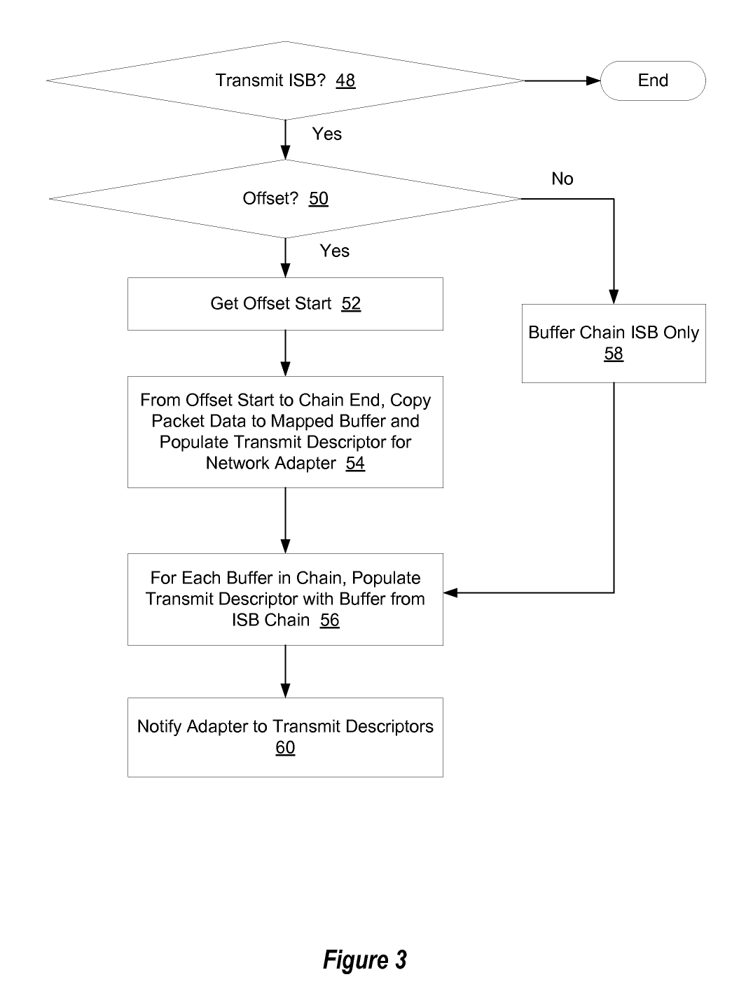

Referring now to FIG. 3, a flow diagram of a process for determining the type of buffer associated with transmission of a packet. The process begins at step 48 with a determination that interface specific buffers are enabled. If so, the process continues to step 50 to determine if any non-interface specific buffers are indicated in a header for a packet buffer chain. If a non-interface specific buffer is indicated, then the process continues to step 52 to retrieve the offset value from the header. At step 54, from the offset start value until the end of the buffer chain, data is copied to mapped buffer space in preparation for transmission and a transmit descriptor is created for access of the data by the network adapter. At step 56, for each buffer value in the chain of the interface specific buffer values provided at step 58, a transmit descriptor is populated. At step 60, the network adapter is notified of the transmit descriptors to transmit the packet.

Although the present invention has been described in detail, it should be understood that various changes, substitutions and alterations can be made hereto without departing from the spirit and scope of the invention as defined by the appended claims.

What is claimed is:

1. A method for communicating a packet through a network adapter, the method comprising:
buffering information for the packet in an interface specific buffer;
tracking the buffering with a chain;
detecting a failure to buffer information for the packet in the interface specific buffer;
buffering all remaining information for the packet in a non-interface specific buffer; and
identifying an offset associated with the buffering in the non-interface specific buffer.

2. The method of claim 1 further comprising:
receiving the chain at a driver of the network adapter;
processing buffered information up to the offset as interface specific buffer information;
processing buffered information after the offset as non-interface specific buffer information; and
communicating the information with the packet from the network adapter.

3. The method of claim 2 wherein processing buffered information up to the offset further comprises identifying the information in the interface specific buffer for transmission from the interface specific buffer.

4. The method of claim 2 wherein processing buffered information after the offset further comprises copying the information from the non-interface specific buffer to a transmit buffer.

5. The method of claim 2 wherein the non-interface specific buffer comprises a system buffer.

6. The method of claim 2 wherein identifying an offset further comprises storing the offset in a header of the chain readable by a driver of the network adapter.

7. The method of claim 1 wherein buffering information is performed by a TCP protocol stack.

8. The method of claim 1 wherein buffering information is performed by a UDP protocol stack.

9. A network adapter comprising:
electronic components operable to send information to a network as packets, the electronic components including a processor and memory having instructions for execution on the processor, the instructions comprising instructions to:
receive a buffer chain that identifies interface specific buffer locations and non-interface specific buffer locations storing information for a packet;
identify an offset value associated with the buffer chain;
process the buffer chain as an interface specific buffer until the offset; and
process the buffer chain as a non-interface specific buffer after the offset.

10. The network adapter of claim 9 wherein the instruction to process the buffer chain as a non-interface specific buffer further comprises copying information from the non-interface specific buffer to a transmit buffer.

11. The network adapter of claim 10 further comprising instructions to send a packet associated with the buffer chain by transmitting the packet from the interface specific buffer and the transmit buffer.

12. The network adapter of claim 11 wherein the non-interface specific buffers comprise system buffers not registered to with the network adapter for sending a packet.

13. A computer system comprising:
a processor operable to process information;
memory interfaced with the processor and operable to store information, the memory including an interface specific buffer, a transmit buffer and a system buffer;
a network adapter interfaced with the memory and operable to read information from the interface specific buffer and transmit buffer to send the information as a packet through a network; and
a transport layer stored in the memory to execute as instructions on the processor to:
store information of a packet for communication over the network in the interface specific buffer;
detect failure to store some of the information of the packet in the interface specific buffer;
in response to the detected failure, storing all remaining information of the packet in the system buffer; and
storing an indicator of the information stored in the system buffer.

14. The computer system of claim 13 further comprising instructions to:
retrieve the indicator; and
apply the indicator to copy the information stored in the system buffer to the transmit buffer.

15. The computer system of claim 14 wherein the instructions stored in the network adapter further comprise an instruction to transmit the packet from the information stored in the interface specific buffer and the transmit buffer.

16. The computer system of claim 15 wherein the transport layer comprises a TCP protocol stack associated with an operating system stored in the memory and executing on the processor.

17. The computer system of claim 15 wherein the transport layer comprises a UDP protocol stack associated with an operating system stored in the memory and executing on the processor.

18. The computer system of claim 13 wherein the indicator comprises an offset that identifies a transition between information of the packet stored in the system buffer and information of the packet stored in the interface specific buffer.

19. The computer system of claim 18 wherein the offset is stored in a header of a packet that lists buffer pointers.

20. The computer system of claim 13 wherein the interface specific buffer and transmit buffer comprise mapped memory locations registered for use with network adapter and the system buffer is not registered for use with the network adapter.
